(19) United States
(12) Patent Application Publication
(10) Pub. No.: US 2015/0052675 A1
(43) Pub. Date: Feb. 26, 2015

(54) Greenhouse Outdoor Shower

(71) Applicant: Steven Desmelyk, Flemington, NJ (US)

(72) Inventor: Steven Desmelyk, Flemington, NJ (US)

(21) Appl. No.: 13/973,066

(22) Filed: Aug. 22, 2013

(51) Int. Cl. A47K 3/28; A01G 9/14

(52) U.S. Cl. CPC A47K 3/28; A01G 9/14
USPC 4/597

(57) ABSTRACT

In a combination outdoor shower and greenhouse, privacy for the shower component is provided by the strategic arrangement of plantings within the greenhouse. Optionally, the shower can be enhanced with heaters, steam generators, mist generators and/or lighting to create a spa, sauna and/or steam-bath effect. The shower and spa enhancements will operate synergistically with the greenhouse plantings, which will be selected and positioned so as to benefit optimally from the temperature, humidity and lighting associated with the shower/spa features.

### BACKGROUND OF THE INVENTION

The present invention relates to the both fields of greenhouses and outdoor showers, and more specifically to the field of an outdoor shower combined with a greenhouse.

In the design of outdoor showers, privacy is a paramount concern. For that reason, outdoor shower enclosures typically have opaque side walls, as disclosed in the U.S. patents of Ray (U.S. Pat. No. 5,790,992) and Graber (U.S. Pat. No. 8,109,044). But, while such opaque enclosures provide privacy, they also eliminate the user's visual experience of being outdoors. Moreover, the liquid and vapor water produced by such typical outdoor showers is wasted after it serves its bathing purpose.

By incorporating an outdoor shower within a greenhouse enclosure, on the other hand, the user's privacy can be maintained by the strategic positioning of plantings to provide screening of the shower area. At the same time, the water, moisture and humidity generated by the shower serve the dual purposes of cooling/rinsing the user's body and watering/misting the greenhouse plantings. In effect, the combination greenhouse-shower creates an aesthetically pleasing and relaxing simulated “rainforest” atmosphere, while also providing an ideal growth environment for plants which require warm and humid conditions.

### SUMMARY OF THE INVENTION

The present invention is a combination outdoor shower and greenhouse. Privacy for the shower component is provided by the strategic arrangement of plantings within the greenhouse (optionally in conjunction within non-transparent panels in the greenhouse enclosure). Optionally, the shower can be enhanced with heaters, steam generators, mist generators and/or lighting to create a spa, sauna and/or steam-bath effect. For areas subject to cold winter temperatures, the heaters will be employed in winter months to maintain a temperature range conducive to plant growth. The shower and spa enhancements operate synergistically with the greenhouse plantings, which are selected and positioned so as to benefit optimally from the temperature, humidity and lighting associated with the shower/spa features.

The foregoing summarizes the general design features of the present invention. In the following sections, a specific embodiment of the present invention will be described in some detail. This specific embodiment is intended to demonstrate the feasibility of implementing the present invention in accordance with the general design features discussed above. Therefore, the detailed description of this embodiment is offered for illustrative and exemplary purposes only, and it is not intended to limit the scope either of the foregoing summary description or of the claims which follow.

### BRIEF DESCRIPTION OF THE DRAWINGS

FIG. 1 is a plan view of a greenhouse outdoor shower according to the preferred embodiment of the present invention.

FIG. 2 is a cutaway perspective view of a greenhouse door enclosure according to the preferred embodiment of the present invention.

### DETAILED DESCRIPTION OF THE PREFERRED EMBODIMENT

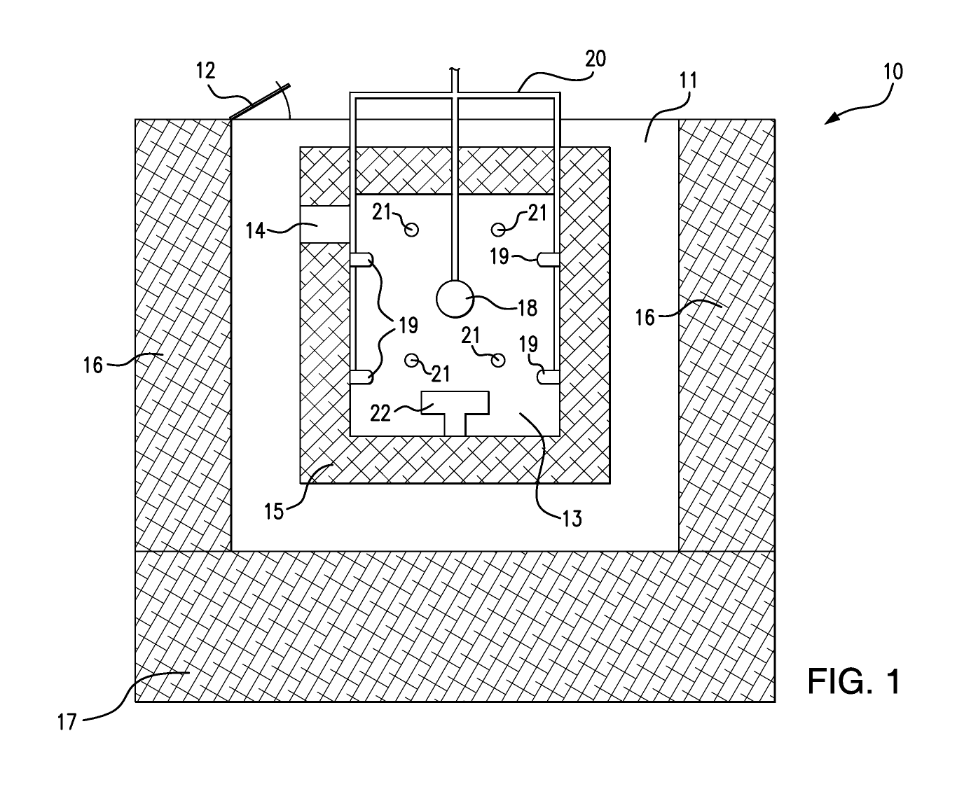

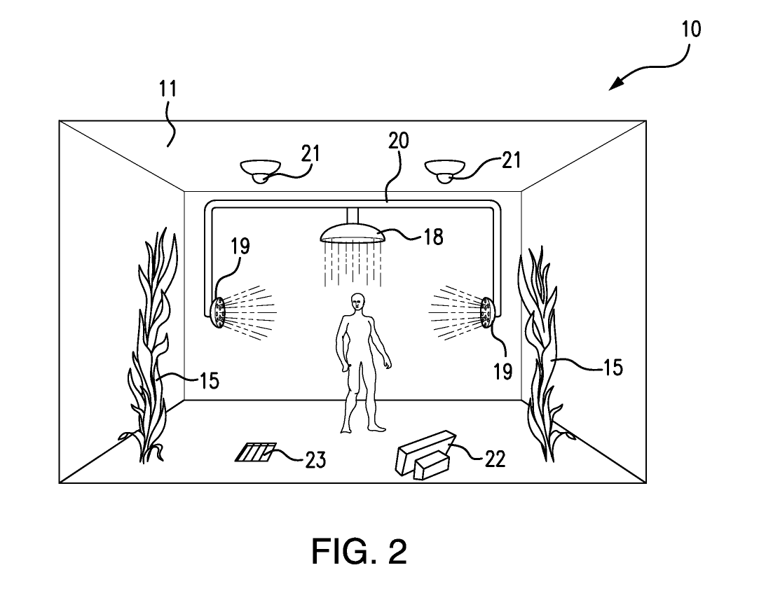

Referring to FIGS. 1 and 2 the preferred embodiment of the present invention 10 comprises a greenhouse enclosure 11 defined by sidewalls and a roof consisting of structurally integrated transparent panels, preferably glass or plexiglass. Access to greenhouse enclosure 11 is through an entry door 12.

Within the central area of the greenhouse enclosure 11 is a shower enclosure 13, with a shower access 14. The shower enclosure 13 is defined by a central planting area 15, comprising plantings having sufficient height and foliage to screen the shower enclosure 13 from outside view. Around the periphery of the greenhouse enclosure 11, there are two side planting areas 16 and a front planting area 17.

Within the shower enclosure 13 is an overhead shower head 18 and multiple misting nozzles 19, all of which have hydraulic connections 20 to a pressurized water source. The shower head 18 operates in the conventional manner to provide a downward stream of water for bodily rinsing/cooling, while the misting nozzles 19 emit a fine spray of water droplets, thereby creating an overall “rainshower” effect. Also within the shower enclosure 13 are multiple overhead LED lights 21, which are preferably colored lights. The visual effect of the LED lights 21 shining through the mist and spray within the shower enclosure enhances the overall aesthetic appeal and helps create a relaxing “rainforest” atmosphere. Optionally, LED lights can also be placed on or near the shower head 18 itself and can be powered by the hydraulic flow to the shower head 18.

The user controls the shower head 18, misting nozzles 19 and LED lights 21 from a control console 22 within the shower enclosure 13. Depending on the external climate in which the greenhouse-shower 10 is located, heating within the greenhouse enclosure 11 can be provided by passive solar heating, space heaters or a central heating system. Solar panels can be incorporated into the greenhouse enclosure to provide a source of electricity for electrical heaters.

The plantings in the central 15, side 16 and front 17 planting areas are strategically selected to take advantage of the moisture and humidity generated within the shower enclosure 13. Accordingly, the plantings in the central planting area 15 will be of a more tropical variety, thriving on high humidity conditions. Plantings in the side planting areas 16 will be adapted to moderate humidity conditions, while those in the front planting area 17 will prefer a dryer environment.

If the shower is not being used on a regular basis, the shower head 18 and misting nozzles 19 can optionally be periodically activated by a timer mechanism incorporated in the central console 22. Drainage within the shower enclosure 13 is provided by one or more floor drains, from which water is directed to the planting areas 15, 16, 17. Alternately, drainage within the shower enclosure 18 can be through a pervious base material, such as stone (not shown).

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A combination outdoor shower and greenhouse, comprising a greenhouse enclosure defined by structurally integrated sheets or panels, including multiple transparent sheets or panels;
a shower enclosure within the greenhouse enclosure, wherein the shower enclosure is defined by a central planting area comprising plantings that screen the interior of the shower enclosure from outside view; and
one or more shower heads within the shower enclosure, wherein the shower head(s) is/are hydraulically connected to a source of pressurized water.

2. The combination outdoor shower and greenhouse according to claim 1, further comprising a means of heating the interior of the greenhouse enclosure.

3. The combination outdoor shower and greenhouse according to claim 2, further comprising one or more misting nozzles within the greenhouse enclosure, wherein the misting nozzle(s) is/are hydraulically connected to a source of pressurized water.

4. The combination outdoor shower and greenhouse according to claim 3, further comprising one or more LED lights within the greenhouse enclosure.

5. The combination outdoor shower and greenhouse according to claim 4, further comprising a control console from which the shower head(s), misting nozzle(s) and LED light(s) are controlled.

6. The combination outdoor shower and greenhouse according to claim 5, further comprising one or more peripheral planting areas within the greenhouse enclosure and around the periphery of the shower enclosure.
